(19) United States
(12) Patent Application Publication
(10) Pub. No.: US 2009/0150692 A1
(43) Pub. Date: Jun. 11, 2009

(54) PORTABLE ULTRASOUND SYSTEM WITH VARIABLE POWER CONSUMPTION

(75) Inventor: McKee D. Poland, Andover, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,789

(22) PCT Filed: Nov. 17, 2005
(86) PCT No.: PCT/IB05/53801

§ 371 Date: May 21, 2007

Related U.S. Application Data
(60) Provisional application No. 60/630,080, filed on Nov. 22, 2004.

(51) Int. Cl. G06F 1/32; H02J 3/14

(52) U.S. Cl. 713/320; 307/31

(57) ABSTRACT

Power is conserved in a portable, ultrasound imaging device (102) by powering off circuits while they are not being utilized and by reducing the power mode of multi-power-mode circuitry when feasible (S420). Power conservation is triggered by a low battery condition (S412), changed device operation mode (S416) or manual user override (S404). The battery supplements power incoming from a peripheral during a low power consumption mode of the device (S530), and is trickle charged at other times (S520).

The present invention relates to power conservation in an electronic device and, in particular, identifying device circuitry currently suitable for powering off or operating in a mode of lower power consumption.

Battery-operated systems suffer from short service duration between battery charges. This problem is exacerbated when the device is portable and when operation is directed to a time-critical function.

A cardiac patient, for example, now benefits from the increasingly widespread usage of portable ultrasound scanners. The scanners operate from a battery, and may be pluggable into an outlet.

However, the present inventor has observed that the power management in these ultrasound imaging devices continues to rely to varying extents on the traditional, non-portable ultrasound scanner architecture. For example, many circuits continue to receive and consume power during device operation modes in which the circuit is not being utilized.

The present invention has been made to address the above-noted shortcomings in the prior art. It is an object of the invention to provide, for an electronic device, an apparatus, a method operable using the. apparatus, and a computer program for performing the method, wherein the apparatus has a circuit selector that identifies device circuitry based on a currently-ongoing device operation mode. The identified circuitry may be of two types: circuitry that is consuming power but is not being utilized and/or circuitry that is being utilized but is operable in a mode of lower power consumption. The apparatus further includes a circuit power controller for powering off the identified circuitry not being utilized and/or for putting the other type of identified circuitry in the lower power consumption mode.

Details of the invention disclosed herein shall be described with the aid of the figures listed below, in which the same or similar elements are identically annotated throughout the several views.

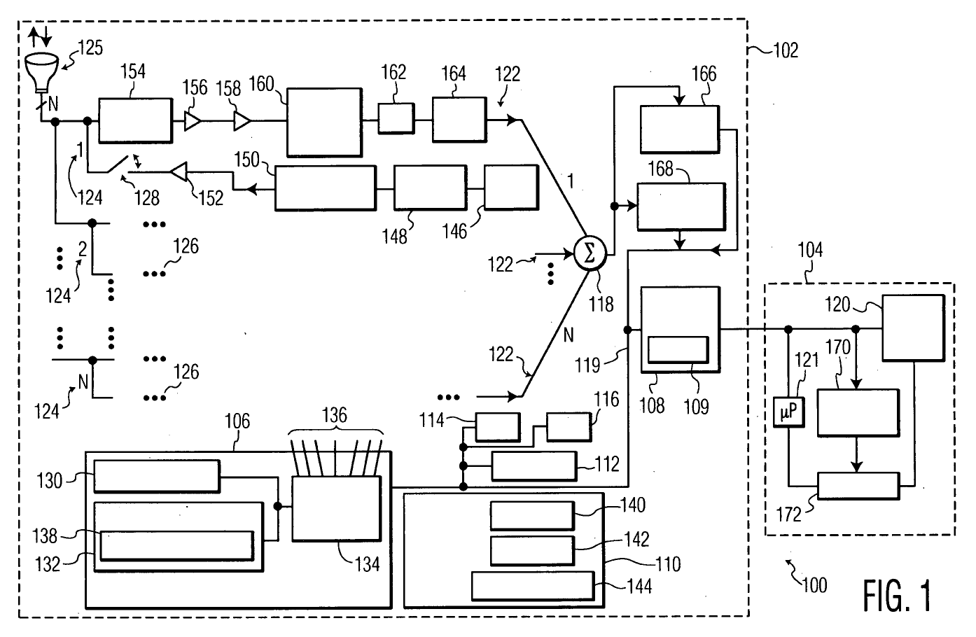

FIG. 1 is a diagram illustrating the components and functionality of an exemplary pulsed-mode (PM) ultrasound scanning system according to the present invention,

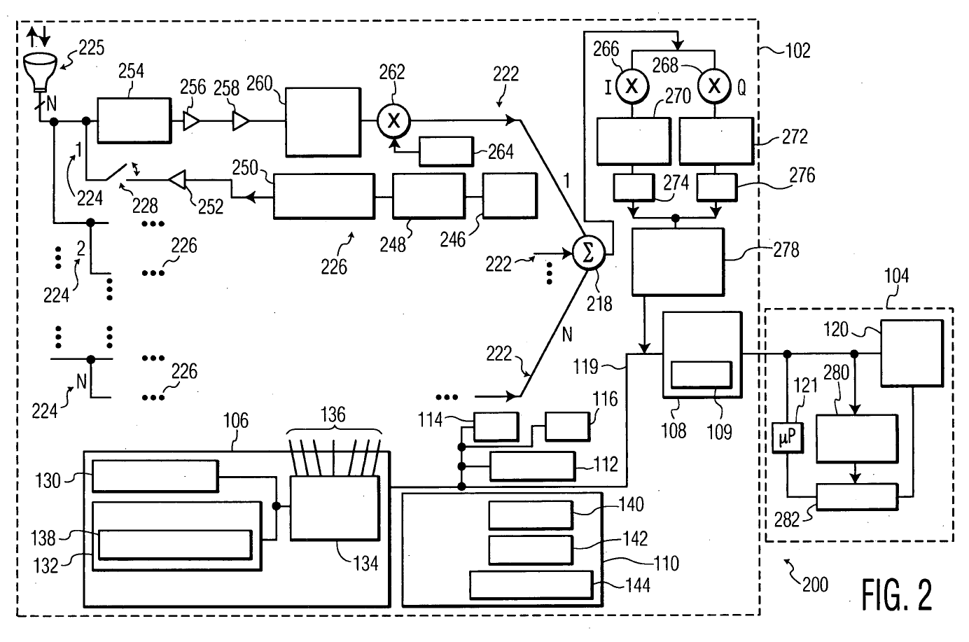

FIG. 2 is a diagram illustrating the components and functionality of an exemplary continuous-wave (CW) ultrasound scanning system according to the present invention;

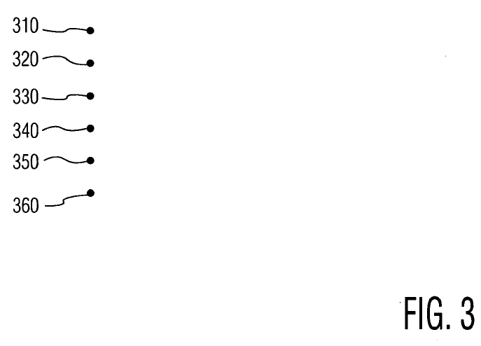

FIG. 3 is a listing of examples of circuitry for powering off according to the present invention;

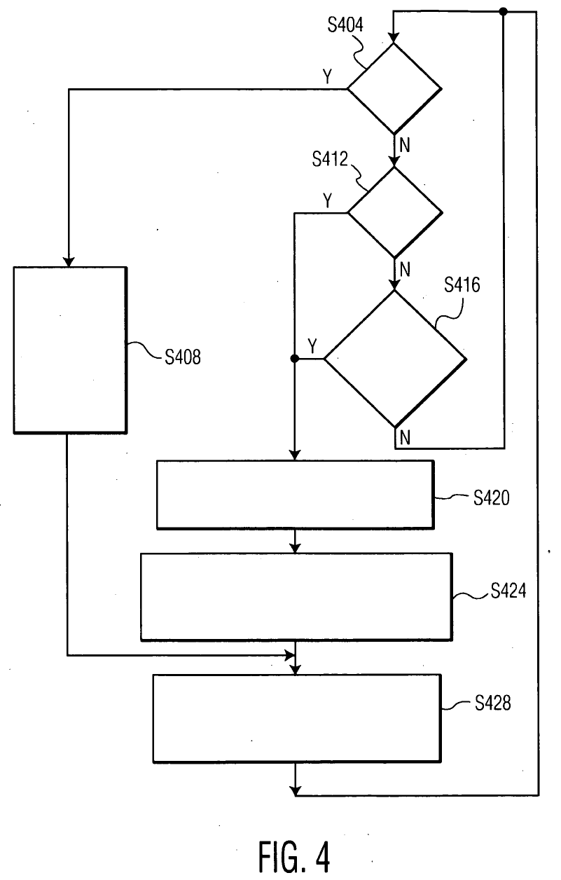

FIG. 4 is a flow chart providing an example of a system operation according to the present invention;

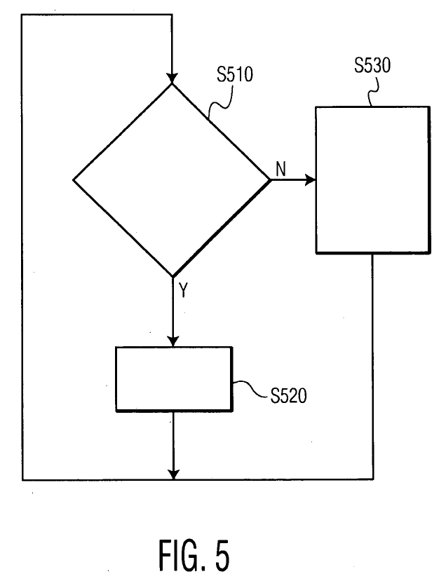

FIG. 5 is a flow chart illustrating an example of input power management according to the present invention; and

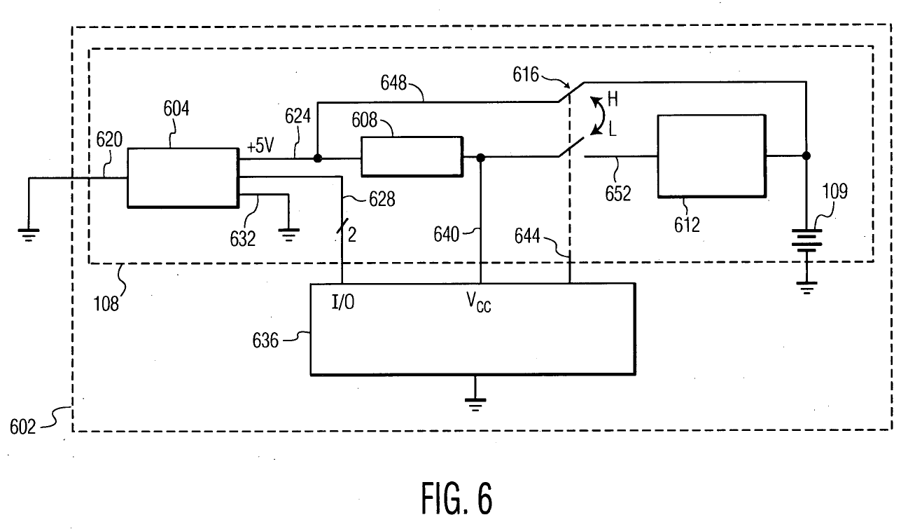

FIG. 6 is a block diagram showing an exemplary system operation in managing input power according to the present invention.

FIG. 1 shows, by way of illustrative and non-limitative example, a pulsed-mode (PM) ultrasound scanning system according to the present invention. The intended scope of the present invention extends to continuous wave (CW) ultrasound scanning systems, and to systems comprising a combination of PM and CW systems. Pulsed-mode systems are characterized by short bursts of acoustic transmit signals from the transducer, followed by a period of reception and processing of echoes. Examples of pulsed-mode imaging include greyscale (also known as B-mode), Color Flow Doppler, Pulsed-Wave (PW) Doppler, and derivatives of these modes. Continuous wave systems are characterized by continuous transmission of acoustic signals from the transducer and simultaneous continuous reception and processing of the return echoes. Continuous wave ultrasound processing is typically used for a Doppler imaging mode. Moreover, the present invention applies to a wide array of electronic devices having circuitry that can be powered off or operated with less power depending upon the mode of device operation, and is not limited to ultrasound, medical or scanning systems.

FIG. 1 combines a functional flow diagram, as indicated by the straight arrows, with a block diagram of system components.

As seen in FIG. 1, a PM ultrasound scanning system 100 has a scanner 102, preferably portable, and a personal computer (PC) 104. The scanner 102 includes a power conservation apparatus 106, an interface unit 108 that includes the stored power supply or battery 109 for the scanner, a user interface 110, a processor 112, a read-only memory (ROM) 114, a random access memory (RAM) 116 and a summer 118. The aforementioned components of the scanner are connected on a data-and-power bus 119. The latter receives power 120 from an outlet the PC 104 is plugged into, and at times additionally from the battery 109. Alternatively, PC 104 may itself be a portable device with its own battery (not shown) which supplies power 120 to scanner 102. Connections from the processor 112 to the other scanner 102 components shown in FIG. 1 have been omitted for simplicity of illustration.

The summer 118 receives input from N ultrasound receive branches 122 of N respective ultrasound channels 124. Each receive branch 122 is connected to an ultrasound probe 125. Each channel 124 also includes an ultrasound transmit branch 126, which is coupled by a transmit switch 128 to the probe 125.

The power conservation apparatus 106 includes a circuit selector 130 which is connected to a flash memory 132 and a circuit power controller 134. Alternatively, the memory 132 may be any type of non-volatile or volatile memory, including any of the variations of read-only memory (ROM) and random access memory (RAM).

The circuit power controller 134 has data connections 136 out to power switches and power controls (not shown) for powering on/off circuitry and for changing the operating power level of circuitry. The data connections 136 are provided for any one or more of the components of the channels 124 shown in FIG. 1, and potentially for the summer 118 and/or the probe 125, as will be explained in detail further below. Other signaling and power connections throughout the scanner 102 have been omitted from FIG. 1 so as to emphasize aspects of the present invention.

The flash memory 132 contains a mode/circuitry table 138 by which the circuit selector 130 identifies, based on the currently ongoing operation mode of the device 102, circuitry that can be powered on/off or circuitry that can be placed in a different power consuming mode. The identification may also be based on present indicators, such as the level of remaining energy in the battery 109, sensed under the control of the processor 112.

The circuit selector 130 determines the current operation mode of the device 102 based on current-system operating parameters inputted from the user interface 110, e.g., from a keyboard 140, mouse 142 and slider controls 144. Parameters may change without continuing user intervention, such as when the focal depth of an ultrasound beam is set to automatically and sequentially increase or decrease step-wise. The current operation mode may also vary cyclically during scanner operation, i.e., from an ultrasound transmit phase to an ultrasound receive phase.

Each ultrasound channel 124 is typically identical and each may correspond to one or more respective transducer elements (not shown) in the probe 125. The elements of the probe 125 may be arranged linearly, in a curved formation, in a multi- line array or in any other known and suitable manner.

Components of the first branch 124 are shown in FIG. 1 as examples of circuitry to which the power saving measures of the present invention can be applied. These components can be added, rearranged, substituted for or otherwise modified in ways known to those of ordinary skill in the art.

The transmit branch 126 includes a focus delay 146, a pulser 148, a pulse waveshaper 150, an amplifier 152 and the switch 128. The focus delay 146 introduces a channel-specific delay to the pulse to be emitted from the probe 125. The differing delays steer and focus the beam to a desired location in the body of the patient or subject to be imaged. The pulser 148 generates a pulse, typically of short duty cycle so that much more time is spent waiting to receive back an echo from the patient caused by the generated pulse. The pulse waveshaper 150 may transform the pulse into a waveform with multiple cycles and an amplitude-modulated envelope, and may additionally change the polarity of the pulse, i.e., from unipolar to bipolar. The amplifier 152 amplifies the pulse so that magnitudes of its returning echoes from different body structures fall within a desired dynamic range. The switch 128 cuts off the transmission phase, because the same transducer elements in the probe 125 that transmit a pulse receive back the echoes immediately thereafter.

The receive branch 122 includes a harmonic filter 154, a pre-amplifier 156, a variable gain amplifier (VGA) that includes time gain compensation (TGC) 158, a Nyquist anti-aliasing filter 160, an analog-to-digital converter (ADC) 162, and a focus delay 164. The harmonic filter 154 filters out particular harmonic frequencies of the returning echo to, for example, improve the contrast in an image of the patient or subject created from echoes that pass through the harmonic filter. The preamplifier 156 amplifies the returning echo which may be faint, depending on the distance and the body tissue it has traveled. The VGA further amplifies the signal to within a desired dynamic range. The VGA also typically performs TGC which increases gain over time, thereby compensating ultrasound magnitude attenuation in accordance with a round-trip path length. The Nyquist anti-aliasing filter 160 removes, from the returning signal, higher frequency signal content that would otherwise undesirably appear in the sampled, digitized signal, due to aliasing, overlaying and interfering with the desired acoustic signal. The ADC 162 converts an analog, a filtered signal into a digital signal. The receive focus delay 164 operates in concert with the transmit focus delay 146 in focusing and steering the ultrasound beam.

As shown by the straight arrows in FIG. 1, which depict an example of the flow of information, the summer 118 adds the signals received from the N channels 124. The summed signal is then received interleavingly scan line-by-scan line in both a grayscale analysis module 166 and a pulsed wave (PW) Doppler analysis module 168. Accordingly, the modules 166, 168 may simultaneously generate both types of imaging. Alternatively, only one type of imaging may be implemented. The analyzed signals from analysis modules 166, 168 are routed through the interface unit 108 to the PC 104. The results of the analyses are received in a display formatter 170, whose display format parameters are typically user-controllable by the PC keyboard or other input means (not shown). The formatted image is then shown on a display 172. The division of components between the scanner 102 and the PC 104 may vary. The analysis modules 166, 168 may, for example, reside within the PC 104, but are preferably located in scanner 102 to allow for control of low power modes by power conservation apparatus 106.

FIG. 2 shows a continuous-wave (CW) ultrasound scanning system 200 containing scanner 202 that, aside from its CW design, is otherwise similar in configuration with the PM scanner 102 of FIG. 1. As mentioned above, FIGS. 1 and 2 can be realized as a single scanner with both PM and CW capability or as a scanner with differing degrees of capability in the two scanning techniques.

The scanner 202 has N channels 224, each with a transmit branch 226 and a receive branch 222. Each channel 224 is connected to the probe 125 by means of its respective channel switch 228. In CW operation, each of at least one transducer element in the probe 125 for a given channel 224 is devoted either to transmitting for that channel or to receiving for that channel, and operates continuously in its respective function. It is possible, however, to adjust the scanner 200 so that particular transducer elements are switched from one function to the other. The aperture of an ultrasound beam can be defined by opening and closing channel switches 228. Opening the switch 228 takes that channel 224 out of the transmit aperture; whereas, closing the switch 228 includes the channel 224 in the transmit aperture. The determination of whether a given channel 224 is in the receive aperture is achieved by controlling the receive gain of pre-amplifier 256 for that channel 224. Alternatively, the receive path of a channel 224 may be disconnected from the probe by means of another switch (not shown) similar to a switch 228. Typically, the transmit and/or receive apertures will be widened, for example, to maintain the same image resolution at a greater focal depth.

The transmit branch 226 includes a phase delay 246 for beam steering and focusing. The transmit branch 226 further includes a transmit pulser 248, a pulse waveshaper 250 and an amplifier 252, the latter three functioning in a manner similar to the counterparts in the transmit branch 126 of the PM scanner 102.

The receive branch includes a low-pass filter (LPF), a pre-amplifier 256, a variable gain amplifier (VGA) 258 and a band-pass filter (BPF) 260. Also included is a first LO mixer 262 that multiplies the incoming signal by a local oscillator (LO) signal, a sinusoidal signal of a particular phase 264.

The resulting signal from each of the branches 224 is summed by the analog signal summer 218. Separate in-phase (I) and quadrature (Q) mixers 266, 268 multiply the summed signal 218 by respectively-phased LO signals (not shown). The mixed signals are processed by corresponding baseband filters 270, 272 and converted to sampled digital data streams by ADCs 274, 276. The digital signals are then analyzed in a CW Doppler shift analysis module 278 and sent through interface unit 108 to PC 204, where they are formatted in a display formatter 280 and displayed on a display 282.

As with the PM scanner 102, the CW scanner 202 identifies, according to the present invention, circuitry to be powered on/off and circuitry whose power consumption mode is subject to change. The circuitry potentially to be identified includes that in the probe 125, channels 224, including circuits in both the transmit and receive paths 226, 222, the analog summer 218, and the mixers, baseband filters, and ADC sampling stages 266 through 276.

FIG. 3 provides some examples of circuitry that can be powered off according to the present invention. Entire channels that are used neither in the transmit nor receive aperture may be powered off. Referring back to FIG. 2, selectively opening channel switches 228 define a transmit aperture. Circuit components in the transmit branch 226 of channels 224 whose switches 228 are open are therefore not utilized and can be powered off. Although such circuits are traditionally left in a low-power consuming state, “powering off” herein is defined as putting into a power mode low enough that the circuitry cannot be used at all. If a channel 224 is not used in the transmit aperture, then components 310 of the transmit branch 226 such as phase delay 246, transmit pulser 248, pulse waveshaper 250, and transmit amplifier 252 may be powered off. If a channel 224 is not used in the receive aperture, other components 320 of the non-used channel 224 may be powered off, e.g., the pre-amplifier 256, the VGA 258, and beam-forming circuitry such as the phase 264 and first mixer 262. In fact, any or all of the elements shown for a channel 224 may be powered off, depending on whether the channel is used in the transmit aperture, receive aperture, or neither. Referring back to FIG. 1, circuit components of channels 124 that are not within the current transmit or receive the aperture may likewise be powered off. Selectively opening switches 128 defines the transducer elements that are within the transmit aperture. Circuit components in the transmit branch 126 of channels 124 whose switches 128 are open are therefore not utilized and can be powered off. Similarly, circuit components in the receive branch 122 of channels 124 that are not used in the current receive aperture may be powered off. Within the currently non-utilized or partially utilized channels 124, the same corresponding elements can be powered off as recited above for the channels 224.

Similarly, as to either the PM or CW system, particular scan lines in an application may have specific transmit and receive apertures that vary from one scan line to the next. The power control for some scan lines may therefore be varied accordingly, powering off those circuits that are not used in the apertures for each particular scan line as described above.

In a pulsed mode of operation, for each scan line, there is a transmit phase which occurs first, during which the transducer elements of probe 125 are driven with a transmit pulse signal. The transmit phase is followed by a corresponding receive phase, during which acoustic signals impinging on transducer elements of probe 125 create receive signals that are routed to the receive branch 122 of channels 124. Although there is a small time overlap at the end of the transmit phase and the beginning of the receive phase, the vast majority of the two phases are non-overlapped. The PM scanner 102 can therefore power off the receive branch 122 while respective transmit branch 126 is transmitting. Likewise, while the receive branch 122 is receiving, in addition to opening the switch 128 to disconnect the transmit branch 126, the transmit branch can also be powered off. The powering off of this circuitry 330, 340 occurs cyclically or periodically, since the transmit and receive phases alternate in each of the channels 124.

In a scanner that combines PM processing with CW processing, the circuitry for one type of processing can be powered off while the other type operates. An example of such a scanner would be one that incorporates both PM and CW features of the scanners 102, 202. A signal incoming the combined scanner goes through both branches concurrently or through a selected branch. Although neither the PM nor CW branch is typically implemented totally in digital or analog circuitry, the PM branch sometimes known as the “digital path” and the CW branch are sometimes known as the “analog branch.”

Other modifications to the operation of the channels 124, 224 are beneficial for minimizing power consumption under conditions determined by power conservation apparatus 106. Noise rejection circuitry 350, in the VGA 158 or in the ADC 162, for example, may be powered off, at a possible cost in image quality. However, the cost may constitute an acceptable tradeoff for extending the useful charge-providing time period for the battery 109, especially if the image quality degradation is minimal. Similarly, supply voltages to certain circuit components such as those mentioned above may be reduced under control of circuit power controller 134. Reducing the supply voltage to the VGA 158, for example, may reduce the dynamic range of its output, thus limiting the signal amplitudes that can be processed in the subsequent stages, again resulting in a reduction of image quality. In a similar fashion, reduction of the transmit drive voltage to the transmit amplifier 152, 252 will reduce the signal-to-noise ratio of the received acoustic echoes as well as the effective penetration of the acoustic pulse. However, power consumption is also reduced during the time the supply voltages are low, and the tradeoff with resulting image quality may again be acceptable.

As mentioned above, PM delay circuits 146, 164 may be powered off according to the aperture or transmit/receive phase of the pulse mode cycle.

After the completion of the transmit/receive phases of a pulsed mode scan line, and before the beginning of the next scan line, there is traditionally a “dead” period, during which there is little or no acquisition circuit activity in the scanner 102. During this time, reverberation echoes in the target medium are allowed to dissipate so that they do not interfere with reception of echoes in the subsequent scan line. This dead time may be expanded, thereby increasing the total scan line time, and resulting in an overall reduction of the image frame rate presented on display 172. The expansion of scan line time further reduces the power consumption of scanner 102 when used in conjunction with the aforementioned methods of powering off circuit components, because the average duration of power-on time per scan-line time is reduced. The tradeoff between a desirably high frame rate and desirable power conservation may be controlled through the adjustment of scan line times by power conservation apparatus 106.

Image acquisition circuitry 360 may also be powered to a lower level or off at the dead time between scan lines, for example.

The list in FIG. 3 is merely exemplary, and the circuitry that can be powered off according to the present invention is not limited to that appearing on the list.

Alternatively, or in addition, all of the above-mentioned image acquisition circuitry of the scanners 102, 202 potentially can be put in a mode of lower power consumption. New families of quad and octal ADCs, for example, offer low-power modes with corresponding tradeoffs in performance such as a dynamic range and a signal-to-noise ratio (SNR). The feature of separate, low-power modes most applies to analog circuitry such the amplifiers 152, 156, 158, but applies in many cases to digital components, e.g., mixer 262.

Operationally, as seen in FIG. 4, the user of the scanner 102, 202 may operate a control 140, 142, 144 on the user interface 110 to override the automatic identification and power adjustment (step S404). By means of the interface 110, as through navigation of menus or screens, the user may, for the appropriate and relevant circuitry, lower or raise the power consumption mode and/or power on/off the circuitry (step S408).

Subject to any prior user override since the scanner was last powered on, the scanner 102, 202 automatically determines when to adjust circuitry input power, as in the case when the processor 112 detects the remaining energy in the battery 109 as having fallen below a predetermined level (step S412). Alternatively, the user can, through the user interface 110, specify how long the user override being made will pre-empt any subsequent, automatic attempt by the scanner 102, 202 to adjust circuitry input power.

Another case of automatic adjustment is when an event-driven change in operation mode is entered by the user over the user interface 110, or occurs in an automatic, step-wise fashion, e.g., a progressing focal depth (step S416). We distinguish here between event-driven mode change and the periodic or cyclical change due, for example, to alternation between the transmit and receive phase of a scan line.

If automatic adjustment is to occur, the circuit selector 130 identifies, based on the currently ongoing operation mode of the scanner 102, 202, power-consuming, non-utilized circuitry for powering off and/or utilized multi-power-mode circuitry to be operated in a different power mode (step S420). The sensed level of the remaining energy in the battery 109 may also be considered in making the identification. For example, if the remaining power is especially low or higher-power-consuming, circuitry may have to be powered off.

Sometimes, operation of multi-power-mode circuitry, such as the above-mentioned new ADCs, in a lower power mode can adversely impact on image quality. The lower power mode can also reduce device functionality. A weaker transmit pulse, for example, may limit the effective range of the focal depth. Considerations of image quality and functionality may conflict with the determination that the battery 109 is low and that a given amount of energy must therefore be conserved. The interplay among these factors can be resolved by prior empirical investigation, so that the results, such as pertinent thresholds, are reflected in the mode/circuitry table 132. The circuit selector 130 may also base a decision upon analytical factors. In either event, the identification of multi-power-mode circuitry to be placed in a mode of lower power consumption may subsequently be limited so as to maintain a given level of image quality and/or device functionality (step S424).

The circuit power controller 134 then powers off circuitry or reduces power to circuitry determined to be powered off or powered down to a lower level (step S428).

FIG. 5 illustrates an exemplary method for input power management of the scanner 102, 202. If the scanner 102, 202 is operating in a low power-consumption mode (step 510), the battery 109 is trickle charged (step S520). Trickle charging charges a battery at a rate sufficiently slow to avoid damage to the battery despite the length of time during which charging occurs. By a low power-consumption mode of the scanner 102, 202, what is meant here is a mode in which power incoming from the PC 104, 204 is sufficient without supplementing from the battery. If, on the other hand, the scanner 102, 202 is not in a low power-consumption mode, then the power supply to scanner 102, 202, instead of being sourced solely by the PC 104, 204, is supplemented with battery power (step S530).

FIG. 6 depicts an exemplary arrangement for the interface unit 108 to implement input power management for a scanner 602 in accordance with the present invention. The interface unit 108 includes a USB connector 604, a voltage regulator 608, a battery charge controller 612, and a double-pole double throw switch 616. Switch 616 is preferably operated electronically by digital logic, and could be implemented with relays or FETs. The USB connector 604 has an input line 620 from the host computer 104, 204. The input line 620 comprises a power line 624 carrying 5 volts, input and output lines 628, and a ground line 632. The input and output lines 628 extend into the data-and-power bus 119. The ultrasound unit 636 in FIG. 6 corresponds to that part of the scanner 102, 202, or their combination, that lies to the left of the interface unit 108 in FIGS. 1 and 2. Also extending into the data-and-power bus 119 is a power line 640 that conveys power being fed from the power line 624 and into the regulator 608. The regulator 608 down-converts voltage from a PC for use by the processor 112, which would typically be a microprocessor requiring a decreased voltage. By means of a control signal line of the date-and-power bus 119, the processor 112 operates the double-pole switch 616. As shown by the curved double-arrow, the switch is thrown downward for the low power-consumption mode determined in step S510, and is thrown upward otherwise. In the upward position, an electrical connection is made on a line 648 from unregulated battery power to the input of regulator 608, for the purpose of supplementing USB port power from connector 604. In the downward position, the connection on line 648 is broken, and an electrical connection is made instead on a line 652 between the output of regulator 608 and the battery charge controller 612, for the purpose of trickle charging the battery 109.

In operation, power from the host PC 104, 204 flows into the ultrasound unit 636 via the power line 640, regardless of whether the switch 616 is in the upward or downward position. If the switch 616 is in the upward position, current flows from the battery 109 over the line 648 to join and add to the current incoming from the PC 104, 204. The combined current travels through the regulator 608, through the line 640 and into the ultrasound unit 636. In effect, the battery current supplements the current from the PC 104, 204. On the other hand, if the switch 616 is in the downward position, the current flow path over the line 648 is broken, but current from the regulator 608 is received by the battery charge controller 612 which trickle-charges the battery. Accordingly, the battery 109 is trickle charged when the scanner 102, 202 is in a state or mode of low power consumption, and, otherwise, the battery power supplements the power from the host peripheral 104, 204.

While there have been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be constructed to cover all modifications that may fall within the scope of the appended claims.

1. A power conservation apparatus (106) for an electronic device (102), said apparatus comprising:
a circuit selector (130) configured to identify, based on a currently-ongoing operation mode (S416) of said device, circuitry of said device that is consuming power but is not being utilized and/or circuitry of said device that is being utilized but is operable in a mode of lower power consumption (S420); and
a circuit power controller (134) configured respectively for powering off the identified circuitry not being utilized and/or for putting in said mode of lower power consumption the identified circuitry operable in the lower power consumption mode (S428).

2. The apparatus of claim 1, wherein said electronic device is portable (102).

3. The apparatus of claim 1, wherein the identifying comprises table lookup (138), based on said currently-ongoing operation mode, to identify circuitry.

4. The apparatus of claim 1, wherein said device has a battery (109), said circuit selector identifies circuitry operable in a mode of lower power consumption, and the identification for the mode of lower consumption is triggered by a predetermined level of remaining energy in the battery (S412).

5. The apparatus of claim 1, wherein at least some of the respective powering off or putting in a mode of lower power consumption is event-driven rather than cyclical (S416).

6. The apparatus of claim 1, wherein said circuit selector is configured for both types of the identification, so that the apparatus is operable to identify, based on said currently-ongoing operation mode, circuitry consuming power but not being utilized and circuitry being utilized but operable in a mode of lower power consumption (S420).

7. The apparatus of claim 1, wherein said device comprises a user input device operable to override respectively said currently-ongoing operation mode, the identification, said powering off and/or said putting, and further operable to select circuitry to be respectively powered off and/or put into a mode of lower power consumption (S404, S408).

8. The apparatus of claim 1, wherein said device includes a rechargeable battery (109) and a port for inputting power (620), said power controller being configured for selectively utilizing energy stored in the battery based on said currently-ongoing operation mode, said power controller being further configured for charging the battery from power incoming through the port while said currently-ongoing operation mode is one characterized by sufficiently low power consumption (612).

9. The apparatus of claim 1, wherein said device comprises an ultrasound device (102).

10. The apparatus of claim 9, wherein said device is configured to be utilized in ultrasound image acquisition (170).

11. The apparatus of claim 10, wherein the identified circuitry includes ultrasound image acquisition circuitry of said device (168).

12. The apparatus of claim 11, wherein the circuit selector is configured for the identification, based on said currently-ongoing operation mode of said device, circuitry of said device that is consuming power but is not being utilized, the identified circuitry comprising, respectively, any one or more of: transducer elements (125), and/or scan lines, not currently forming a given ultrasound beam (310, 320, 360); pulse-mode circuitry (124) while continuous wave circuitry (224) is operating, and/or vice versa; while transmitting ultrasound pulses (126), ultrasound pulse receiving circuitry (122, 330); and, while receiving ultrasound pulses, ultrasound transmitting circuitry.

13. The device of claim 1, comprising said apparatus of claim 1 (106).

14. The apparatus of claim 1, wherein said powering off occurs down to a level at which the circuitry powered off cannot be utilized in said device (S420).

15. The apparatus of claim 1, further including a user input device operable to override respectively said powering off and/or said putting so as to power on circuitry and/or put circuitry in a mode of higher power consumption (S408).

16. A power conservation apparatus (106) for an imaging device (102) having a battery (109), said apparatus comprising:
a circuit selector (130) for identification, based on a current operation mode of said device, currently-operating circuitry for powering off, the identification being triggered by detection of a predetermined remaining level of energy in the battery; and
a circuit power controller (134) for powering off the identified circuitry.

17. The apparatus of claim 16, wherein said identified circuitry comprises noise rejection circuitry (350).

18. A power conservation method for an imaging device (102), said method comprising:
identifying, based on a currently-ongoing operation mode of said device, circuitry of said device that is consuming power but is not being utilized and/or circuitry of said device that is being utilized but is operable in a mode of lower power consumption (S420); and
respectively powering off the identified circuitry not being utilized and/or putting in said mode of lower power consumption the identified circuitry operable in the lower power consumption mode (S428).

19. The method of claim 18, further comprising:
predetermining, for a particular operation mode of said device, that operating circuitry in a mode of lower power consumption will not sufficiently degrade image quality and/or functionality of said device, said putting being subject to the predetermination (S424).

20. A computer software product for an imaging device, said device including a medium readable by a processor, said product residing within the medium and containing instructions executable to perform acts including:
identifying, based on a currently-ongoing operation mode of said device, circuitry of said device that is consuming power but is not being utilized and/or circuitry of said device that is being utilized but is operable in a mode of lower power consumption (S420); and
respectively powering off the identified circuitry not being utilized and/or putting in said mode of lower power consumption the identified circuitry operable in the lower power consumption mode (S428).
